(19) United States
(12) Patent Application Publication
(10) Pub. No.: US 2015/0093088 A1
(43) Pub. Date: Apr. 2, 2015

(54) Fiber Optic Terminal Assemblies

(71) Applicant: Optema Technology Limited, Limerick (IE)

(72) Inventors: Bret A. MATZ, Leesburg, VA (US); Basheer A. ALIKUNJU, Kochi (IN); Biji Mathew ARAKKAKUDY, Kochi (IN); Mukund MURALEEDHARAN, Kochi (IN); Anoop K. MURALI, Kochi (IN); Renjith RAJAN, Kochi (IN); Sajan CHACKO, Kochi (IN)

(21) Appl. No.: 14/042,008

(22) Filed: Sep. 30, 2013

(51) Int. Cl. G02B 6/44

(52) U.S. Cl. CPC G02B 6/4452
USPC 385/135

(57) ABSTRACT

A fiber optic terminal assembly comprises a mounting plate configured to be mounted to a surface, a pivot bracket comprising a handle, and a spool rotatably mounted to the pivot bracket and configured to store a multi-fiber optic cable. The spool comprises an adapter for securing a connection between a fiber of the multi-fiber optic cable and a fiber of an output fiber cable. The spool and the pivot bracket are configured to be selectively coupled to the mounting plate. A method of using the fiber optic terminal assembly comprises paying out a multi-fiber optic cable stored on the spool by rotating the spool relative to the pivot bracket. The method also comprises selectively coupling the spool and the pivot bracket to a mounting plate after paying out the multi-fiber optic cable. Selectively coupling the spool and the pivot bracket substantially prevents rotation of the spool.

### BACKGROUND

1. Field

Embodiments relate to fiber optic networks and, particularly, to fiber optic terminal assemblies used in fiber optic networks.

2. Background

Fiber optic terminal assemblies (FTAs) are used to optically interconnect multiple fibers, for example, fibers originating from a common point, and distribute them to multiple locations using output fiber optic cables. Typically, the optical connections are made between a larger multi-fiber optic input cable and output single-fiber optic cables. FTAs may be used in buildings such as multi-unit residences or commercial/office buildings to facilitate this optical coupling. One or more FTAs may be used per building depending on the fiber connection needs and capacity of the building.

One recurring issue faced when dealing with the installation of FTAs, is the length required for the input multi-fiber optic cable to connect the FTA to some common point connected to a larger fiber network, for example, a city-wide fiber optic network. Typically, the FTA's physical position is determined before the required length of multi-fiber optic cable between the FTA and the common point is known. This presents two problems. First, one must approximate and prepare a length of the multi-fiber fiber optic input cable before installing the FTA. If the approximated length is too short, the connection to the FTA requires a fiber optic cable splice and another length of input multi-fiber optic cable. Conversely, if the approximated length is too long, then the excess slack of the input fiber optic cable must be stored somewhere along the length of fiber optic cable, potentially introducing unwanted bends and thus unwanted bend loss into the fiber optic cable path. Second, FTAs are sometimes relocated. And to have the correct the length of the input multi-fiber optic cable, the FTA may have to be relocated to an undesirable location. Accordingly there is a need to safely store excess fiber optic cable after installation and to feed fiber optic cable from an installed FTA. There is also a need for a convenient way to store the input fiber optic cable prior to installation of the FTA.

### SUMMARY

In some embodiments, a fiber optic terminal assembly may comprise a mounting plate configured to be mounted to a surface, a pivot bracket comprising a handle, and a spool rotatably mounted to the pivot bracket and configured to store a multi-fiber optic cable. The spool may comprise an adapter for securing a connection between a fiber of the multi-fiber optic cable and a fiber of an output single-fiber cable. The spool and the pivot bracket are configured to be selectively coupled to the mounting plate.

In some embodiments, a method of using a fiber optic terminal assembly comprises paying out a multi-fiber optic cable stored on a spool rotatably mounted to a pivot bracket. The multi-fiber optic cable may be paid out by rotating the spool relative to the pivot bracket. The multi-fiber optic cable is optically coupled to an adapter mounted on the spool. The method also includes selectively coupling the spool and the pivot bracket to a mounting plate after paying out the multi-fiber optic cable. Selectively coupling the spool and the pivot bracket substantially prevents rotation of the, spool.

In some embodiments, a fiber optic terminal assembly may comprise a pivot bracket comprising a handle and a spool rotatably mounted to the pivot bracket. The spool may be configured to store a multi-fiber optic cable and comprises an adapter for securing a connection between a fiber of the multi-fiber optic cable and a fiber of an output fiber cable. The spool and the pivot bracket are configured to be selectively coupled to a surface of an enclosure and such that, when coupled to the surface of the enclosure, rotation of the spool is substantially prevented.

Further features and advantages of the embodiments, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the embodiments and, together with the description, further serve to explain the principles of the embodiments and to enable a person skilled in the relevant art(s) to make and use the embodiments.

FIG. 1 is a perspective view of a fiber optic terminal assembly (FTA) according to an embodiment.

FIG. 2 is a plan view of the FTA of FIG. 1 mounted in an enclosure according to an embodiment.

FIG. 3 is a perspective exploded view of a spool, a pivot bracket, and a mounting plate of the FTA of FIG. 1 according to an embodiment.

FIG. 4 is a perspective exploded view of the spool and the pivot bracket of the FTA of FIG. 1 according to an embodiment.

FIG. 5 is a perspective rear view of the spool and the pivot bracket of the FTA of FIG. 1 according to an embodiment.

FIG. 6 schematically depicts a multi-unit building application of an FTA according to an embodiment.

FIG. 7 is a perspective exploded view of a spool, a pivot bracket, and a portion of an enclosure according to an embodiment.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Embodiments of the present invention will now be described in detail with reference to embodiments thereof as illustrated in the accompanying drawings, in which like reference numerals are used to indicate identical or functionally similar elements. References to an “embodiment” indicate that the embodiment described may include a particular feature, structure, or characteristic, but every embodiment may not necessarily include the particular feature, structure, or characteristic. Moreover, descriptions of embodiments do not necessarily refer to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

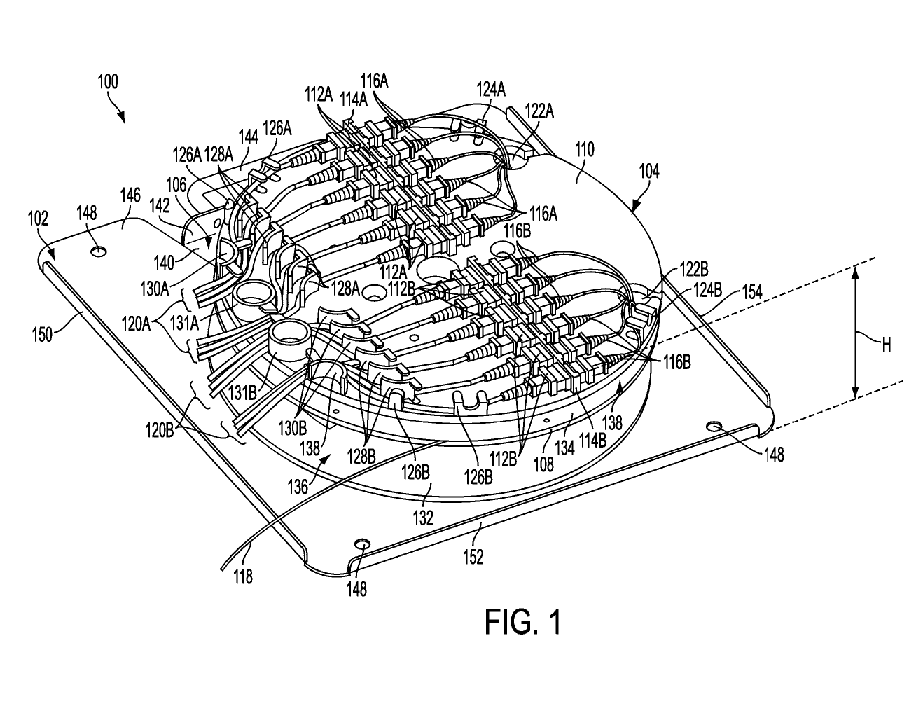

Embodiments of the present invention include a fiber optic terminal assembly (FTA) 100. In some embodiments, FTA 100 comprises a mounting plate, a pivot bracket, and a rotatable spool. FIGS. 1-5 illustrate an embodiment of an FTA comprising a mounting plate 102, a pivot bracket 106, and a spool 104. Embodiments of FTA 100 are described below with collective reference to FIGS. 1-5.

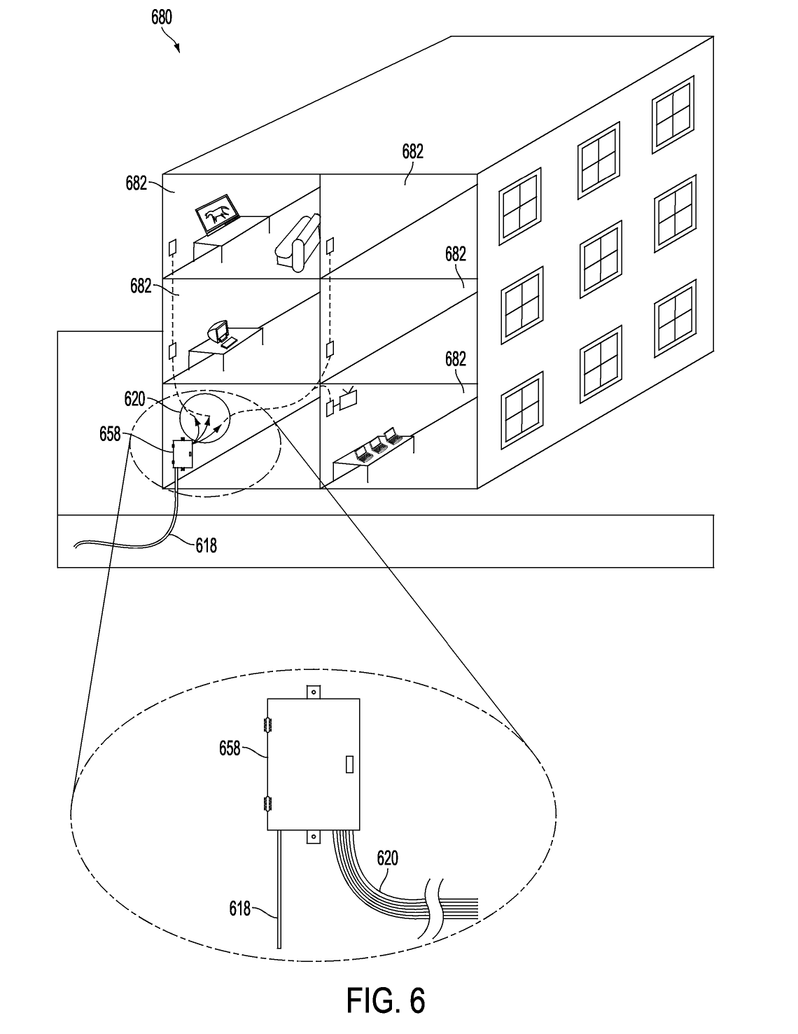

With reference to FIG. 6, exemplary operation of FTA 100 according to an embodiment of the present invention will be described. A multi-unit building 680 according to one embodiment of the invention may include several separate units 682, one or more of which have a necessity or desire to have fiber optic cable service in their unit. Each separate unit 682 typically only needs a single output fiber optic connection 684, but a typical situation in a multi-unit building 680 would have some plurality of units (if not the entire building) needing or desiring the fiber optic cable service. The fiber optic cable provider will run a larger bundled input fiber optic cable 618 to the multi-unit building 680 where it is routed and connected through an FTA 100 (not shown in FIG. 6) as described below with reference to FIGS. 1-5. The FTA 100 can be secured to a surface. For example, as shown in FIG. 6, the FTA 100 can be secured to a surface inside an enclosure 658. Enclosure 658 can be mounted to an interior wall within building 680. In some embodiments, enclosure 658 can be an electrical box installed between studs of wall. Enclosure 658 can be located, for example, in the basement or in a communication closet within multi-unit building 680. Input fiber optic cable 618 can be, for example, multiple fibers bundled together into a single, larger cable for easier routing to some central location. Input fiber optic cable 618 is coupled to the FTA 100. At the FTA 100, the individual fibers that compose input fiber optic cable 618 are separately connected to individual fiber of output fiber optic cables 620. Then each output fiber optic cable 620 is touted to a separate unit 682, where the output fiber optic cable 620 can be connected to other equipment that is capable of translating the fiber optic cable signal into useful information.

In some embodiments, mounting plate 102 may be configured to mount against a surface. Spool 104 may be rotatably mounted to pivot bracket 106 and configured to store an input multi-fiber optic cable tail 118. In some embodiments, pivot bracket 106 and spool 104 may collectively be configured to selectively couple to mounting, plate 102. In some embodiments, pivot bracket 106 may include a handle 144 so that a user can easily operate or carry pivot bracket 106 and spool 104 when decoupled from mounting plate 102, as further described below.

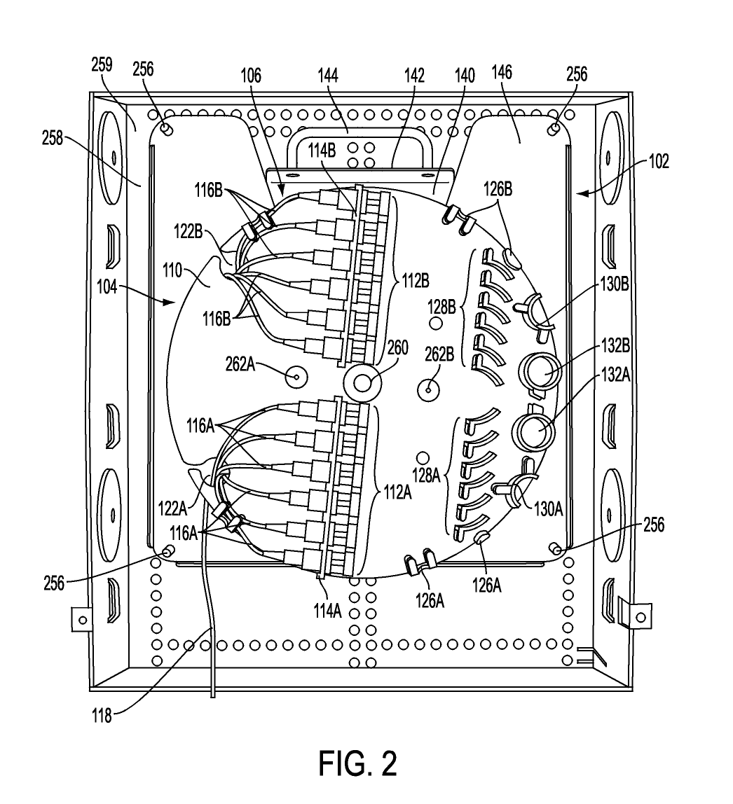

In some embodiments, mounting plate 102 may be mounted to an interior wall of a building, a surface of an enclosure (for example, a panel 259 of an enclosure 258 in FIG. 2), or any other desirable mounting surface. Mounting plate 102 may have a shape configured to conform to the mounting surface. For example, if mounting plate 102 will be mounted to a flat surface, mounting plate 102 may be substantially flat (as shown in FIGS. 1-3) for mounting against the mounting surface.

In some embodiments in which FTA 100 is mounted in enclosure 258, enclosure 258 is a flush mounted wall enclosure mounted between studs in a wall. In such embodiments, FTA 100 may have a height H less than the width of studs in the wall. For example, in one embodiment, FTA 100 may have a height H less than about 3.75 inches—the width of the studs.

Mounting plate 102 may include a main panel 146 that is adjacent the mounting surface when mounted. Main panel 146 may define a plurality of mounting holes 148 configured to receive fasteners 256 that secure mounting plate 102 to the mounting surface. Fasteners 256 may be any suitable fastener, for example, nails, screws, bolts, or ny-latches. In some embodiments, mounting plate 102 may use other suitable, non-fastener means of attachment to mount mounting plate 102 to the mounting surface.

Main panel 146 may have any suitable shape. Mounting plate 102 may be made of any suitable rigid material, for example, wood, plastic, metal, or any other suitable material.

Mounting plate 102 may include a plurality of flanges extending from outer edges of main panel 146 to increase the stiffness of main panel 146. For example, as shown in FIG. 1, mounting plate 102 may include a first flange 150 extending from a first edge of main panel 146, a second flange 152 extending from a second edge of main panel 146, and a third flange 154 extending from a third edge of main panel 146. In some embodiments, first, second, and third flanges 150, 152, and 154 are formed by bending the edges of main panel 146.

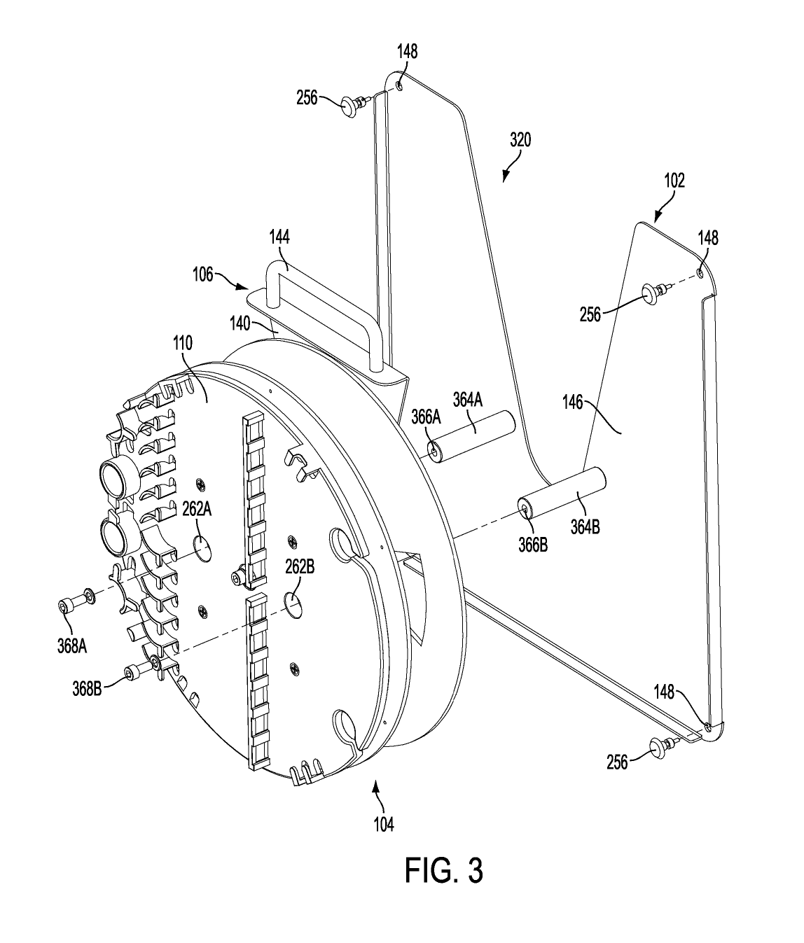

As shown, for example, in FIG. 3, main panel 146 may define a recess 370. Recess 370 may have a shape that corresponds to a shape of a main panel 140 of pivot bracket 106. Although recess 370 has a substantially V-shape in some embodiments, as shown in FIG. 3, recess 370 may have any suitable curvi-linear shape.

Mounting plate 102 may include one or more posts that extend from main panel 146. As shown, for example, in FIGS. 2 and 3, mounting plate 102 includes a first post 364A and a second post 364B extending from main panel 146. First and second posts 364A and 364B are configured to be selectively received within channels 262A and 262B, respectively, defined by spool 104 as described farther below. In some embodiments, when first and second posts 364A and 364B are received in channels 262A and 262B defined by spool 104, rotation of spool 104 relative mounting plate 102 and pivot bracket 106 is substantially prevented.

Referring to FIG. 3, first and second posts 364A and 364B may define first and second bores 366A and 366B, respectively, configured to receive first and second fasteners 368A and 368B to secure spool 104 and pivot bracket 106 to mounting plate 102. In some embodiments, fasteners 368A and 368B may be threaded screws, and first and second bores 366A and 366B may be threaded accordingly.

Spool 104 and pivot bracket 106 may be configured to, be selectively and collectively coupled to mounting plate 102. In one embodiment, pivot bracket 106 is configured to rotatably support spool 104. Pivot bracket 106 may also include a handle 144. Handle 144 allows a user to easily maneuver the subassembly of spool 104 and pivot bracket 106. For example, handle 144 facilitates easy paying out and respooling of multi-fiber optic cable tail 118 stored on spool 104. A user can use one hand to grab handle 144 and lift pivot bracket 106 and spool 104 off a surface to allow spool 104 to freely rotate. The user can then use the other hand to pay out multi-fiber optic cable tail 118 stored on spool 104 by rotating spool 104 or pulling multi-fiber optic cable tail 118. Handle 144 may eliminate the need for a separate fixture designed for holding a cable reel, for example, a de-reeling stand, during installation or uninstallation.

Pivot bracket 106 may include a main panel 140. Main panel 140 of pivot bracket 106 may be made of any suitable rigid material, for example, wood, plastic, metal, or any other suitable material. In some embodiments, pivot bracket 106 may include a flange 142 extending from an edge of main panel 140. Handle 144 may be coupled to flange 142 using any suitable attachment means, for example, fasteners, interference fit, or adhesives. In some embodiments, flange 142 increases the stiffness of main panel 140, improving maneuverability of the subassembly of pivot bracket 106 and spool 104.

In some embodiments, main panel 140 of pivot bracket 106 has a shape that corresponds with the shape of recess 370. Accordingly, when pivot bracket 106 and spool 104 are selectively coupled to mounting plate 102, main panel 140 of pivot bracket 106 is planar with main panel 146 of mounting plate 102.

In some embodiments, handle 144 has an elongated, substantially U-shape as shown in FIGS. 1-5. This shape creates a gap for a user to insert the user's fingers and grab the handle. Although handle 144 has substantially U-shape in FIGS. 1-5, handle 144 can have any other suitable shape configured to allow a user to securely grab handle 144 and manipulate pivot bracket 106 and spool 104.

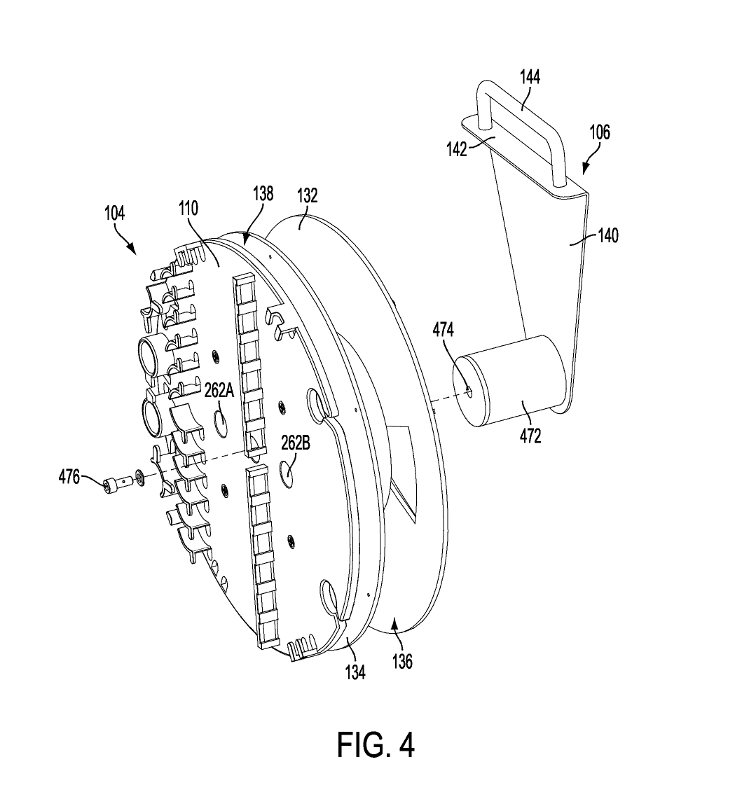

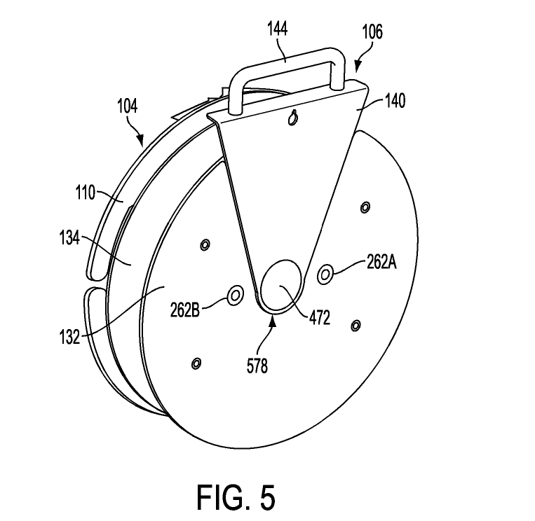

As shown, for example, in FIGS. 4 and 5, pivot bracket 106 may include a post 472 extending from main panel 140 of pivot bracket 106. Post 472 may be sized to be closely received within a channel 578 defined by spool 104. When channel 578 of spool 104 receives posts 472, spool 104 is rotatable, about post 472 and relative to pivot bracket 106. Post 472 may define a bore 474 configured to receive a fastener 476 to secure, spool 104 to pivot bracket 106. In some embodiments, fastener 476 may be a threaded screw, and bore 474 may be threaded accordingly.

In one embodiment, FTA 100 may also include spool 104 mounted to pivot bracket 106 such that it can freely rotate relative to pivot bracket 106. Spool 104 may include a spooling region 108, an adapter plate 110, and one or more adapters.

Spooling region 108 may include a base flange 132 and a spaced apart intermediate flange 134. Base flange 132 and intermediate flange 134 define a first cable spooling area 136. Spooling region 108 may also include a second spooling area 138 defined by intermediate flange 134 and adapter plate 110. First spooling area 136 is configured to spool one or more input multi-fiber optic cable tails 118. In some embodiments, each multi-fiber optic cable tail 118 may have six or twelve fibers within a single fiber jacket. In some embodiments, first spooling area 136 is configured to spool 50 ft., 100 ft., 200 ft., 350 ft., or more than 350 ft. of input multi-fiber optic cable tail 118. Input multi-fiber optic cable tail 118 may be paid out to the maximum storage capacity of first spooling area 136. Input multi-fiber optic cable tail 118 is optically coupled to a first plurality of input single-fiber optic cables 116A and a second plurality of input single-fiber optic cables 116B (collectively referred to as input single-fiber optic cables 116). In some embodiments, the fibers of multi-fiber optic cable tail 118 are unbundled and optically coupled to the fibers of the single-fiber optic cables 116 using a fan out device (not shown). Second spooling area 138 may be used to spool input single-fiber optic cables 116. In some embodiments, the ends of each of the input single-fiber optic cables 116 can have connectors, for example, SC/APC connectors.

Adapter plate 110 may include a first plurality of adapters 112A and a second plurality of adapters 112B (collectively referred to as adapters 112). In some embodiments, adapter plate 110 includes a total of twelve adapters 112. In some embodiments, adapter plate 110 includes less than twelve adapters 112 or more than twelve adapters 112. Adapters 112 may be configured to secure connections between fibers of input single-fiber optic cables 116 and fibers of a first plurality of output single-fiber optic cables 120A and a second plurality of output single-fiber optic cables 120B (collectively referred to as output single-fiber optic cables 120). Each input, single-fiber optic cable 116 may be connected to a respective adapter 112. In some embodiments, adapters 112 may be SC/APC adapters.

As shown, for example, in FIGS. 1 and 2, adapter plate 110 may also include a first adapter mounting panel 114A and a second adapter mounting panel 114B (collectively referred to as adapter mounting panels 114). Adapter mounting panels 114 extend from adapter plate 110. Adapter mounting panels 114 are configured to securely couple adapters 112 to adapter plate 110. In some embodiments, adapter mounting panels 114 each define a channel that closely receives adapters 112 to create an interference fit. In some embodiments, adapters 112 are secured to adapter mounting panels 114 using any other suitable attachment mechanism, for example, fasteners or adhesives. In some embodiments, first plurality of adapters 112A are coupled to adapter plate 110 on one side of adapter plate 110, and second plurality of adapters 112B are coupled to adapter plate 110 on the opposite side of adapter plate 110.

Adapter plate 110 may define a first slot 122A and a second slot 122B that allow first plurality of input single-fiber optic cables 116A and second plurality of input single-fiber optic cables 116B, respectively, to pass from second spooling area 138 to a front face of adapter plate 110. In some embodiments, first slot 122A is on the same side of adapter plate 110 as first plurality of adapters 112A, and second slot 122B is on the same side of adapter plate 110 as second plurality of adapters 112B.

Adapter plate 110 may also include a first input edge guide 124A and a second input edge guide 124B (collectively referred to as input edge guides 124) extending from a surface of adapter plate 110. Input edge guides 124 keep input single-fiber optic cables 116 within the boundary of adapter plate 110. In some embodiments, first edge guide 124A is on the same side of adapter plate 110 as first plurality of adapters 112A, and second edge guide 124B is on the same side of adapter plate 110 as second plurality of adapters 112B.

Each output single-fiber optic cable 120 may be connected to a respective adapter 112. In some embodiments, output single-fiber optic cables 120 are routed to a separate unit of a multi-unit building (for example, separate unit 682 of multi-unit building 600 of FIG. 6). At the separate unit, output single-fiber optic cables 120 may be optically coupled to equipment that is capable of translating the fiber optic cable signal into useful information.

Adapter plate 110 may also include a first plurality of output edge guides 126A and a second plurality of output edge guides 126B (collectively referred to as output edge guides 126) extending from an outer edge of a surface of adapter plate 110. Output edge guides 126 keep output single-fiber optic cables 120 within the boundary of adapter plate 110. In some embodiments, first plurality of edge guides 126A is on the same side of adapter plate 110 as first plurality of adapters 112A, and second plurality of edge guides 126B is on the same side of adapter plate 110 as second plurality of adapters 112B.

Adapter plate 110 may also include a first plurality of output intermediate guides 128A and a second plurality of output intermediate guides 128B (collectively referred to as output intermediate guides 128) extending from a surface of adapter plate 110 at an output side of output edge guides 126. Output intermediate guides 128 may be arcuate as shown in FIGS. 1 and 2. In other embodiments, intermediate guides 128 may have any other suitable shape. Intermediate guides 128 route output single-fiber optic cables 120 in a desired direction. In some embodiments, first plurality of output intermediate guides 128A is on the same side of adapter plate 110 as first plurality of adapters 112A, and second plurality of output intermediate guides 128B is on the same side of adapter plate 110 as second plurality of adapters 112B.

Adapter plate 110 may also include a first exit edge guide 130A and a second exit edge guide 130B (collectively referred to as exit edge guides 130) extending from a surface of adapter plate 110 at an output side of output intermediate guides 128. Exit edge guides 130 may be arcuate as shown in FIGS. 1 and 2. In other embodiments, intermediate guides 128 may have any other suitable shape. Output intermediate guides 128 direct output single-fiber optic cables 120 in a desired direction to exit FTA 100. In some embodiments, first exit edge guide 130A is on the same side of adapter plate 110 as first plurality of adapters 112A, and second exit edge guide 130B is on the same side of adapter plate 110 as second plurality of adapters 112B. Exit edge guides 130 keep output single-fiber optic cables 120 within the boundary of adapter plate 110.

Using output edge guides 126, output intermediate guides 128, and exit edge guides 130, output single-fiber optic cables 120 are routed from adapters 112 in a safe and organized manner. In some embodiment, output edge guides 126, output intermediate guides 128, and exit edge guides 130 extend perpendicular from the plane of adapter plate 110. Output edge guides 126, output intermediate guides 128, and exit edge guides 130 can have specific radii that do not allow output single-fiber optic cables 120 to bend more than the specification of output single-fiber optic cables 120 allows, thereby minimizing bend loss within output single-fiber optic cables 120. Thus, output edge guides 126, output intermediate guides 128, and exit edge guides 130 provide a convenient and organized way to route the output single-fiber optic cables 120 through FTA 100. In some embodiments, one or more of output edge guides 126, output intermediate guides 128, and exit edge guides 130 may be omitted.

Adapter plate 110 may define one or more finger or hand grips to allow a user to easily rotate spool 104. For example, as best seen in FIGS. 1 and 2, adapter plate 110 may include a first cylindrical wall 131A and a second cylindrical wall 131B (collectively referred as cylindrical walls 131) that extend from a surface of adapter pate 110. Cylindrical walls 131 define channels configured to receive a user's fingers. In some embodiments, cylindrical walls 131 may also function as an output cable guide that routes output single-fiber optic cables 120 in a desired direction.

Spool 104 can feed input multi-fiber optic cable tail 118 up to the maximum spool capacity. Multi-fiber optic cable tail 118 may then be routed as needed and any excess of multi-fiber optic cable tail 118 may be manually retracted onto spool 104 by rotating spool 104. For example, a user can respool multi-fiber optic cable tail 118 on first spooling area 136 by placing a finger in the channel defined by one of the cylindrical walls 131 and thereby rotating spool 104. The excess of multi-fiber optic cable tail 118 does not have to be stored outside of FTA 100, but rather can be safely re-spooled onto first spooling area 136 of spool 104. This configuration may help avoid unnecessary damage such as bends or pinches of input multi-fiber optic cable tail 118, which can drastically reduce the signal quality that input multi-fiber optic cable tail 118 is capable of transmitting.

As shown, for example, in FIG. 2, spool 104 may define a first channel 262A and a second channel 262B (collectively referred to as channels 262). Channels 262 are configured to receive posts 364 of mounting plate 102 (see FIG. 3), respectively. When channels 262 receive posts 364, rotation of spool 104 relative to pivot bracket 106 is substantially prevented.

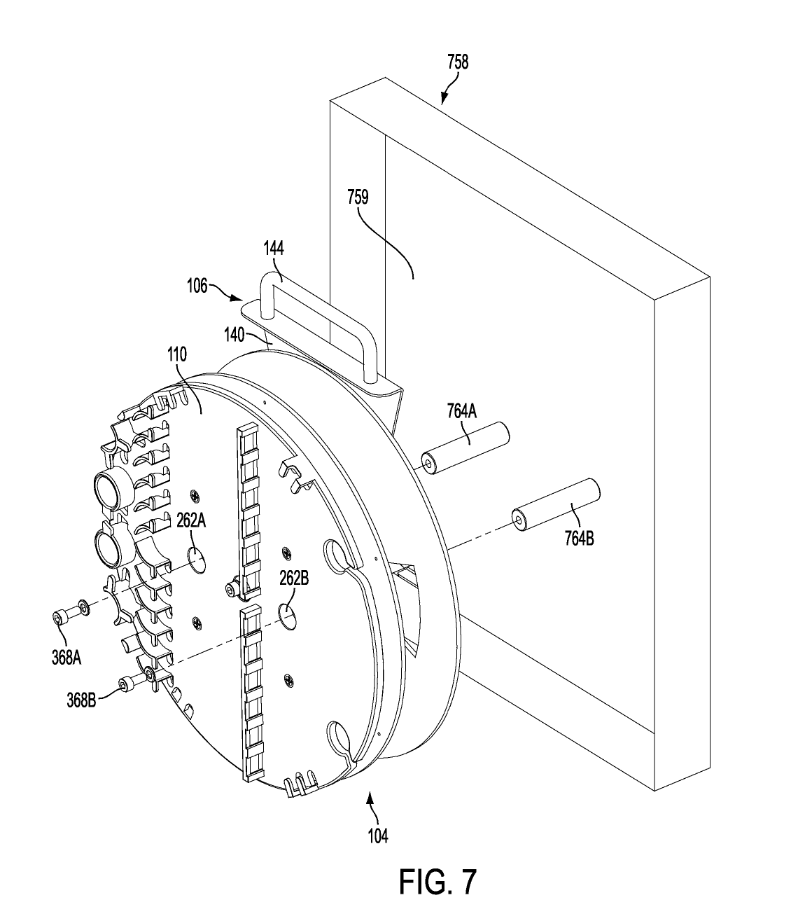

In some embodiments, mounting plate 102 may be omitted, and the subassembly of spool 104 and pivot bracket 106 may be selectively and directly coupled to a panel 759 of an enclosure 758. FIG. 7 is a perspective exploded view of spool 104, pivot bracket 106, and a portion of an enclosure 758 according to such an embodiment. Spool 104 and pivot bracket 106 may be configured such that when the subassembly of spool 104 and pivot bracket 106 is selectively coupled to panel 759 of an enclosure 758, rotation of spool 104 is substantially prevented. For example, enclosure 758 may include one or more posts, for example, two posts 764A and 764B, similar to posts 364A and 364B that extend from panel 759. Posts 764A and 764B extending from panel 759 are configured to be selectively received within channels 262A and 262B, respectively, defined by spool 104. When posts 764A and 764B are received in channels 262A and 262B defined by spool 104, rotation of spool 104 relative to pivot bracket 106 is substantially prevented.

Methods of using the above-described embodiments of FTA 100 will now be described. A user can pay out input multi-fiber optic cable tail 118 stored on spool 104 by rotating spool 104 relative to pivot bracket 106. A user may pay out input multi-fiber optic cable tail 118 until the end of input multi-fiber optic cable tail 118 reaches a common point of a larger fiber optic network, for example. Multi-fiber optic cable tail 118 is optically coupled to adapters 112 on spool 104 via single-fiber optic cables 116. In some embodiments, a user pays out output multi-fiber optic cable tail 118 while the subassembly of spool 104 and pivot bracket 106 are decoupled from mounting plate 102. The user may manipulate the subassembly of spool 104 and pivot bracket 106 by grabbing handle 144 with one hand, and rotating spool 104 or pulling multi-fiber optic cable tail 118 with the other hand using the finger grips on adapter plate 110, for example, the channels defined by cylindrical walls 131.

After input multi-fiber optic cable tail 118 is paid out, a user can selectively couple the subassembly of spool 104 and pivot bracket 106 to mounting plate 102. In some embodiments, the user aligns channels 262 of spool 104 with posts 364 of mounting plate 102 and advances the subassembly of spool 104 and pivot bracket 106 toward mounting plate 102 until channels 262 receive posts 364. To secure the subassembly of spool 104 and pivot bracket 106 to mounting plate 102, the user can insert fasteners 368 into bores 366. In some embodiments, mounting plate 102 is already mounted to a surface, for example, a surface of an interior wall or a surface of an enclosure, when the subassembly of spool 104 and pivot bracket 106 is selectively coupled to mounting plate 102. After selectively coupling spool 104 and pivot bracket 106 to mounting plate 102, rotation of the spool 104 is substantially prevented. In some embodiments, the user decouples spool 104 and pivot bracket 106 from mounting plate 102 before paying out input multi-fiber optic cable tail 118.

To respool input multi-fiber optic cable tail 118 on first spooling area 136, a user can uncouple the subassembly of spool 104 and pivot bracket 106 from mounting plate 102. The user may manipulate the subassembly of spool 104 and pivot bracket 106 by grabbing handle 144 with one hand, and rotating spool 104 with the other hand using the finger grips on adapter plate 110, for example, the channels defined by cylindrical walls 131.

It is to be appreciated that the Detailed Description section, and not the Summary and Abstract sections (if any), is intended to be used to interpret the claims. The Summary and Abstract sections (if any) may set forth one or more but not all exemplary embodiments as contemplated by the inventor(s), and thus, are not intended to limit the embodiments or the appended claims in any way.

While the embodiments have been described herein with reference to exemplary embodiments for exemplary fields and applications, it should be understood that the subject matter is not limited thereto. Other embodiments and modifications thereto are possible, and are within the scope and spirit of the subject matter. For example, and without limiting the generality of this paragraph, embodiments are not limited to the entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

The breadth and scope of the embodiments should not be limited by any of the above-described exemplary embodiments, but should be defined only in accordance with the following claims and their equivalents.

1. A fiber optic terminal assembly, comprising:
a mounting plate configured to be mounted to a surface;
a pivot bracket comprising a handle; and
a spool rotatably mounted to the pivot bracket and configured to store a multi-fiber optic cable, the spool comprising an adapter for securing a connection between a fiber of the multi-fiber optic cable and a fiber of an output fiber cable,
wherein the spool and the pivot bracket, are configured to be selectively coupled to the mounting plate.

2. The fiber optic terminal assembly of claim 1, wherein the mounting plate, the spool, and the pivot bracket ale configured such that, when the spool and the pivot bracket are selectively coupled to the mounting plate, rotation of the spool is substantially prevented.

3. The fiber optic terminal assembly of claim 2, wherein:
the mounting plate comprises a panel and a post extending from the panel;
the spool defines a channel configured to receive the post; and
when the post is received within the channel, rotation of the spool is substantially prevented.

4. The fiber optic terminal assembly of claim 1, wherein:
the mounting plate defines a recess; and
the pivot bracket comprises a panel having a shape that substantially corresponds to a shape of the recess.

5. The fiber optic terminal assembly of claim 1 wherein the pivot bracket further comprises a panel and a flange extending from an end of the panel, the handle being coupled to the flange.

6. The fiber optic terminal assembly of claim 1, wherein:
the pivot bracket comprises a panel and a post extending from the panel; and
the spool defines a channel configured to receive the post such that the spool is rotatable about the post.

7. The fiber optic terminal assembly of claim 1, wherein the surface comprises a panel of an enclosure.

8. The fiber optic terminal assembly of claim 1, wherein the fiber optic terminal assembly has a height less than about 3.5 inches.

9. The fiber optic terminal assembly of claim 1, wherein:
the spool further comprises a plate;
the adapter is mounted to the plate; and
the plate defines a space configured to receive a finger of a user to allow a user to rotate the spool.

10. A method of using a fiber optic terminal assembly, comprising:
paying out a multi-fiber optic cable stored on a spool rotatably mounted to a pivot bracket by rotating the spool relative to the pivot bracket, the multi-fiber optic cable being optically coupled to an adapter mounted on the spool; and
selectively coupling the spool and the pivot bracket to a mounting plate, wherein the selectively coupling the spool and the pivot bracket substantially prevents rotation of the spool.

11. The method of claim 10, wherein selectively coupling the spool and the pivot bracket to the mounting plate occurs after paying out the multi-fiber optic cable.

12. The method of claim 10, further comprising mounting the mounting plate to a surface.

13. The method of claim 12, wherein the surface is a panel of an enclosure.

14. The method of claim 12, wherein mounting the mounting plate to the surface occurs before selectively coupling the spool and the pivot bracket to the mounting plate.

15. The method of claim 10, wherein paying out the multi-fiber optic cable comprises holding a handle of the pivot bracket.

16. The method of claim 10, further comprising demounting the spool and the pivot bracket from the mounting plate.

17. The method of claim 16, wherein demounting the spool and the pivot bracket from the mounting plate occurs before paying out the multi-fiber optic cable.

18. The method of claim 16, wherein demounting the spool and the pivot bracket from the mounting plate occurs after the paying out the multi-fiber optic cable; and
further comprising respooling the multi-fiber optic cable on the spool after demounting the spool and the pivot bracket from the mounting plate.

19. The method of claim 18, wherein respooling the multi-fiber optic cable tail 118 on the spool comprises holding a handle of the pivot bracket with one hand and rotating the spool with a second hand.

20. A fiber optic terminal assembly, comprising:
a pivot bracket comprising a handle; and
a spool rotatably mounted to the pivot bracket and configured to store a multi-fiber optic cable, the spool comprising an adapter for securing a connection between a fiber of the multi-fiber optic cable and a fiber of an output fiber cable,
wherein the spool and the pivot bracket are configured to be selectively coupled to a surface of an enclosure and such that, when coupled to the surface of the enclosure, rotation of the spool is substantially prevented.
